(19) United States
(12) Patent Application Publication
(10) Pub. No.: US 2024/0351501 A1
(43) Pub. Date: Oct. 24, 2024

(54) ANIMAL SUPPORT

(71) Applicant: Joseph James Richard Arnault, Little Smoky (CA)

(72) Inventor: Joseph James Richard Arnault, Little Smoky (CA)

(21) Appl. No.: 18/636,082

(22) Filed: Apr. 15, 2024

Related U.S. Application Data
(60) Provisional application No. 63/461,196, filed on Apr. 21, 2023.

(51) Int. Cl. B60P 1/54

(52) U.S. Cl. CPC B60P 1/54

(57) ABSTRACT

An animal support has a load bearing frame has with a first upright support, a second upright support, and a top end that secures the first upright support in spaced relation to the second upright support. The load bearing frame is stabilized in an upright orientation by a lateral support having a first lateral member, a second lateral member, and a connector. The connector is configured to attach to an anchor, the first lateral member connects the anchor to the first upright support; and the second lateral member connects the anchor to the first upright support. A load attachment is supported at the top end of the load bearing frame that suspends an animal relative to the ground surface and within an animal receiving area below the top end of the load bearing frame and between the first and second upright supports.

### TECHNICAL FIELD

This relates to a support, in particular a support for an animal carcass.

### BACKGROUND

After being hunted, wild game may be hung or suspended in the air to facilitate cleaning or to load the carcass onto a truck bed or trailer. U.S. Pat. No. 7,913,980 (Cipriano) entitled “Adjustable, collapsible and portable game hoist” discloses a device for suspending game for processing.

### SUMMARY

According to an aspect, there is provided an animal support, comprising a load bearing frame having a first upright support, a second upright support, and a top end that secures the first upright support in spaced relation to the second upright support such that the load bearing frame defines an animal receiving area below the top end and between the first upright support and the second upright support. A load attachment is at the top end of the load bearing frame, the load attachment being supported by the first upright support and the second upright support. A lateral support has a first lateral member, a second lateral member, and a connector, wherein the connector is configured to attach to an anchor, the first lateral member connects the anchor to the first upright support, the second lateral member connects the anchor to the first upright support, and in use, the lateral support stabilizes the load bearing frame in an upright orientation relative to a ground surface with the load attachment adapted to suspend an animal relative to the ground surface.

According to other aspects, the animal support may include one or more of the following features, alone or in combination: the first support and the second support may comprise ground-engaging feet at a bottom end opposite the top end; the connector may comprise a hitch attachment adapted to connect to a hitch or hitch receiver of a vehicle; the load attachment may comprise a game hoist; the first upright support and the second vertical support may comprise an adjustable height; the top end may comprise a top connector that extends between the first upright support and the second upright support; the top connector, the first upright support, and the second upright support may be rigidly connected by releasable connectors such that the frame is collapsible; the first lateral member and the second lateral member may be connected to the connector by a pivotal connector that has a vertical pivot axis; the first lateral member and the second lateral member may each comprise a sliding sleeve that engages the respective first upright support and the second upright support such that a vertical position of the lateral frame along the load bearing frame is adjustable.

According to another aspect, there is provided a method of suspending an animal carcass, the method comprising the steps of:
assembling an animal support by: erecting a load bearing frame on a ground surface in an upright orientation such that a first upright support, a second upright support, and a top end of the load bearing frame define a carcass receiving area, the load bearing frame comprising a load attachment at the top end; and supporting the load bearing frame in the upright orientation by securing a lateral support between the load bearing frame and an anchor, the lateral support comprising a connector attached to the anchor, a first lateral member that connects the anchor to the first upright support, and a second lateral member that connects the anchor to the first upright support; and
suspending the animal carcass from the load attachment and within the carcass receiving area.

According to other aspects, the method may comprise one or more of the following features, alone or in combination: the method may comprise the step of attaching ground-engaging feet to a bottom of the first upright support and the second upright support; securing the lateral support may comprise securing the connector to a hitch of a vehicle; the load attachment may comprise a game hoist and suspending the animal carcass may comprise hoisting the animal carcass using the game hoist; the method may further comprise the step of adjusting a height of the first and second vertical supports; the first lateral support and the second lateral support may be pivotally connected to the connector and securing the lateral support may comprise pivoting the first lateral support and the second lateral support from a collapsed position to a deployed position; the first lateral support and the second lateral support may each comprise a sliding sleeve and the method may further comprise the step of adjusting a position of the first lateral support and the second lateral support by sliding the siling sleeves along the first upright support and the second upright support; the top end may comprise a top connector and assembling the animal support may comprise connecting releasable between the top connector and the first upright support and the second upright support.

Other aspects will be apparent from the specification below.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is an elevated front view of an animal support.

FIG. 2 is an elevated side view of an animal support.

FIG. 3 is a top plan view of an animal support.

FIG. 4 is an elevated side view of an animal support connected to a vehicle.

FIG. 5 is an elevated front view of an animal support holding an animal carcass.

FIG. 6 is a plan view of a disassembled animal support.

### DETAILED DESCRIPTION OF PREFERRED EMBODIMENTS

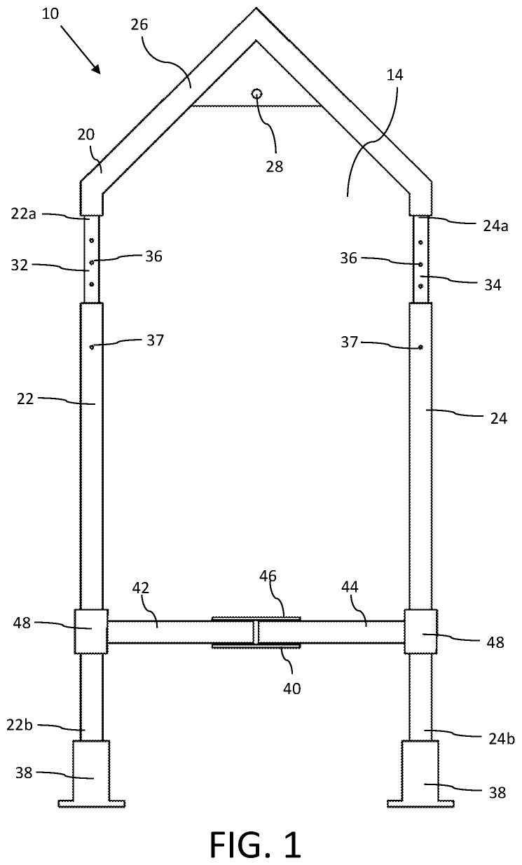

An animal support, generally identified by reference numeral 10, will now be described with reference to FIG. 1 through 6.

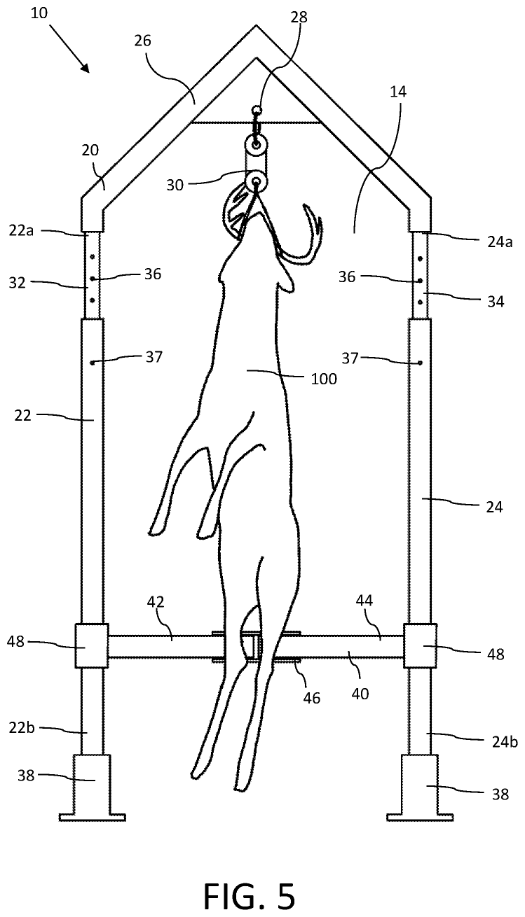

Referring to FIG. 5, animal support 10 is designed to suspend objects, such as an animal carcass 100 as shown, above the ground surface, such as to facilitate cleaning animal carcass 100 and/or loading animal carcass 100 into a vehicle bed. Referring to FIG. 4, animal support 10 has a load bearing frame 20 and a lateral frame 40 that provides lateral support to load bearing frame 20 when connected to a supporting structure 60, such as the hitch receiver 62 of a vehicle 60 as will be discussed in more detail below. Animal support 10 may be designed to be portable, such that individual components can be disassembled for transport, and may be manufactured from aluminum or other suitable rigid material.

Referring to FIG. 1, load bearing frame 20 has a first upright support 22 and a second upright support 24 that are oriented in an upright position, such as in a vertical plane 12, and are attached together at a top end 22a and 24a of upright supports 22 and 24. Top end 24a may include a top connector 26 that rigidly secures a top end 22a of first upright support 22 to a top end 24a of second upright support 24. As depicted, top connector 26 may be a V-shaped component that is removable from first and second upright supports 22 and 24, however it will be understood that top connector 26 may be fixed to one of top end 22a or top end 24a, formed by more than one component, or be defined by first and second upright supports 22 and 24. Top connector 26 may also have other shapes, such as a rounded or squared U-shape, and may be an integrally formed part of one or both of upright supports 22 and 24. As depicted, load bearing frame defines an animal receiving area 14 below top end 22a and 24a and between first upright support 22 and second upright support 24.

Load bearing frame 20 has a load attachment point 28 carried by top connector 26 that is supported by the first and second upright supports 22 and 24. Referring to FIG. 5, attachment point 28 is capable of supporting a load within animal receiving area 14, such as animal carcass 100. Load attachment point 28 may be an aperture located at or below the vertex of top connector 26, to which an attachment is secured, which may be a game hoist 30 as shown, or other device for suspending a load. It may be beneficial to use an attachment that facilitates raising or lowering a load, such as a pulley system. In one example, a cable from a winch may be threaded over a pulley, which may then be used to raise and lower carcass 100.

Referring to FIG. 1, first and second upright supports 22 and 24 may be height adjustable and may include a first telescoping support 32 and a second telescoping support 34, respectively, that slide relative to first and second upright supports 22 and 24 such that the height of animal support 10 may be adjusted. Telescoping supports 32 and 34 may be received within upright supports 22 and 24 and may be secured by aligning holes 36 and inserting a pin 37. Top ends 22a and 24b may be located on telescoping supports 32 and 34, and top connector 26 may be connected to telescoping supports 32 and 34. A bottom end 22b and 24b of upright supports 22 and 24 may have detachable feet 38 that engage the ground surface to support some or all of the weight of animal support 10. Feet 38 may be fixed to supports 22 and 24 or supports 22 and 24 may sit in feet 38. The position of feet 38 may also be adjusted to ensure proper engagement with the ground.

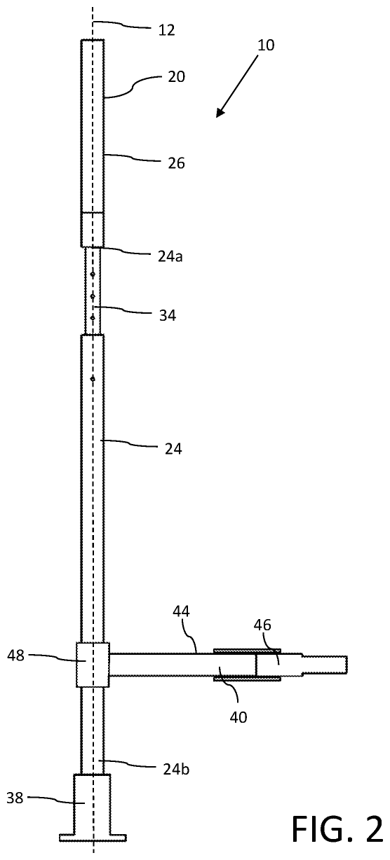

Referring to FIG. 2, lateral support 40 of animal support 10 provides lateral support and stability to load bearing frame 20 when a load is placed on attachment point 28 by preventing lateral movement or tipping of upright supports 22 and 24, when lateral support 40 is connected to an anchor 60, such as a vehicle or other type of supporting structure. Referring to FIG. 4, anchor 60 may be a vehicle that connects to lateral support via a hitch 62. In one example, hitch 62 may be a hitch receiver and connector 46 may be adapted to be inserted within the hitch receiver. Other types of hitch connections may also be used. Anchor 60 preferably has sufficient weight and is sufficiently stable to provide adequate lateral support as discussed below.

Connector 46 may be spaced from vertical plane 12 such that it will not interfere with an animal located in animal receiving area 14. In the depicted example, a first lateral support 42 extends between connector 46 and first upright support 22 and a second lateral support 44 extends between connector 46 and second upright support 24. First and second lateral supports 42 and 44 engage first and second upright supports 22 and 24 to support load bearing frame 20 by transferring any lateral forces into supporting structure. As shown, lateral supports 42 and 44 are oriented horizontally and upright supports 22 and 24 are oriented vertically, which allows for an efficient load-bearing design with the ground surface supporting the load and connector 46 providing stability while transferring a minimal amount of load to anchor 60. Other angles may also be used, depending on the preferences of the user.

As depicted, lateral supports 42 and 44 may have sliding sleeves 48 that slidably engage upright supports 22 and 24 to provide lateral support, while also allowing vertical movement of lateral frame 40 relative to load bearing frame. Typically, animal support 10 is connected to a vehicle, which may have weight added or removed from it while animal support 10 is connected. A slidable engagement between lateral frame 40 and load bearing frame 20 allows for a height of the vehicle to vary. In other examples, lateral supports 42 and 44 may be fixed to upright supports 22 and 24.

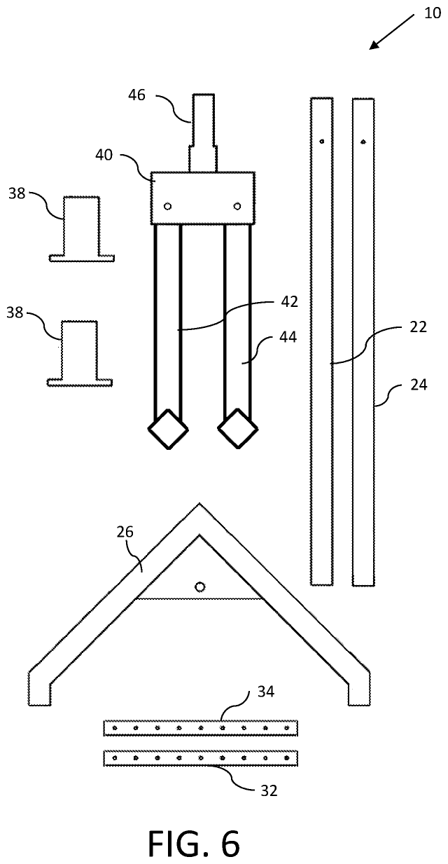

Referring to FIG. 6, animal support 10 may be collapsible for storage and transport. In the depicted example, lateral supports 42 and 44 may be pivotally connected to connector 46 to enable folding of lateral frame 40 when animal support is not in use, and may be removable from upright supports 22 and 24. Upright supports 22 and 24 may be disassembled by detaching feet 38, top connector 26, and removing telescoping supports 32 and 34. In other examples, some components may not be detachably connected, and there may be additional connections, or in other words, the various components may be made up differently than as shown.

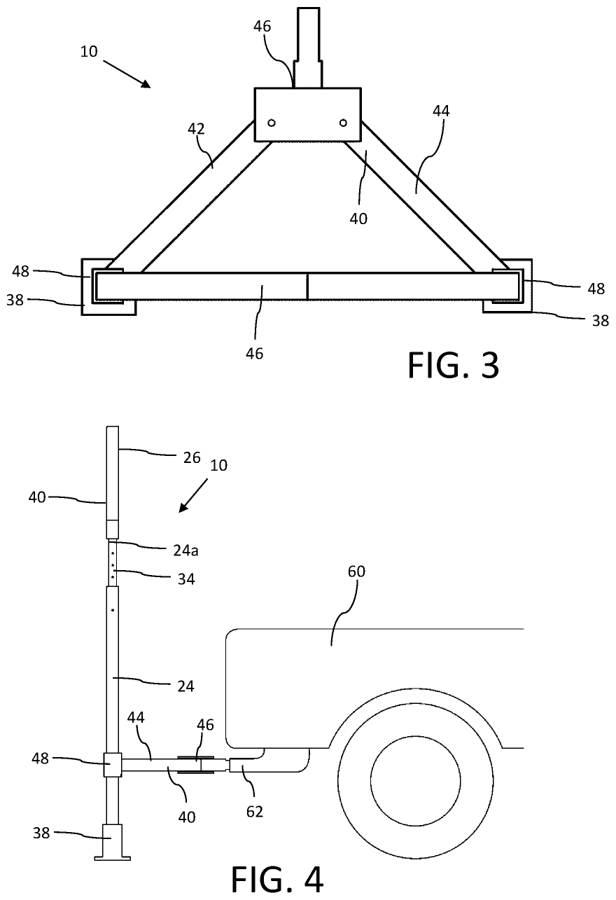

A method of erecting and using animal support 10 will now be disclosed. Referring to FIG. 4, lateral frame 40 is connected to supporting structure 60, such as by inserting connector 46 into a hitch receiver 62 of a vehicle. Referring to FIG. 3, lateral supports 42 and 44 may be pivoted into a desired position, and feet 38 may be positioned underneath sliding sleeves 48. Referring to FIG. 2, top connector 26 is attached to first and second upright supports 22 and 24, which are connected to first and second lateral supports 42 and 44, such as by inserted second ends 22b and 24b through sliding sleeves 48 and into feet 38. Referring to FIG. 1, the height of top connector 26 may be adjusted by inserting telescoping sleeves 32 and 34 into upright supports 22 and 24 and fixed in a desired position. Top ends 22a and 24a are rigidly secured relative to one another with top connector 26. Referring to FIG. 5, game hoist 30 may be attached to load attachment point 28 and carcass 100 may be hoisted to facilitate cleaning or loading into a vehicle. A vehicle may be backed toward animal support 10, or where anchor 60 is the hitch receiver of a truck, carcass 100 will already be suspended adjacent to the bed of truck 60, and hoist 30 may be actuated to lower carcass 100 as carcass 100 is pulled further into the bed of truck 60.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings, but should be given the broadest interpretation consistent with the description as a whole.

What is claimed is:

1. An animal support, comprising:
a load bearing frame having a first upright support, a second upright support, and a top end that secures the first upright support in spaced relation to the second upright support such that the load bearing frame defines an animal receiving area below the top end and between the first upright support and the second upright support;
a load attachment at the top end of the load bearing frame, the load attachment being supported by the first upright support and the second upright support; and
a lateral support having a first lateral member, a second lateral member, and a connector, wherein:
the connector is configured to attach to an anchor;
the first lateral member connects the anchor to the first upright support;
the second lateral member connects the anchor to the first upright support; and
in use, the lateral support stabilizes the load bearing frame in an upright orientation relative to a ground surface with the load attachment adapted to suspend an animal relative to the ground surface.

2. The load support of claim 1, wherein the first support and the second support comprise ground-engaging feet at a bottom end opposite the top end.

3. The animal support of claim 1, wherein the connector comprises a hitch attachment adapted to connect to a hitch or hitch receiver of a vehicle.

4. The animal support of claim 1, wherein the load attachment comprises a game hoist.

5. The animal support of claim 1, wherein the first upright support and the second upright support comprise an adjustable height.

6. The animal support of claim 1, wherein the top end comprises a top connector that extends between the first upright support and the second upright support.

7. The animal support of claim 6, wherein the top connector, the first upright support, and the second upright support are rigidly connected by releasable connectors such that the frame is collapsible.

8. The animal support of claim 1, wherein the first lateral member and the second lateral member are connected to the connector by a pivotal connector that has a vertical pivot axis.

9. The animal support of claim 8, wherein the first lateral member and the second lateral member each comprises a sliding sleeve that engages the respective first upright support and the second upright support such that a vertical position of the lateral frame along the load bearing frame is adjustable.

10. A method of suspending an animal carcass, the method comprising the steps of:
assembling an animal support by:
erecting a load bearing frame on a ground surface in an upright orientation such that a first upright support, a second upright support, and a top end of the load bearing frame define a carcass receiving area, the load bearing frame comprising a load attachment at the top end; and
supporting the load bearing frame in the upright orientation by securing a lateral support between the load bearing frame and an anchor, the lateral support comprising a connector attached to the anchor, a first lateral member that connects the anchor to the first upright support, and a second lateral member that connects the anchor to the first upright support; and
suspending the animal carcass from the load attachment and within the carcass receiving area.

11. The method of claim 10, further comprising the step of attaching ground-engaging feet to a bottom of the first upright support and the second upright support.

12. The method of claim 10, wherein securing the lateral support comprises securing the connector to a hitch of a vehicle.

13. The method of claim 10, wherein the load attachment comprises a game hoist, and suspending the animal carcass comprises hoisting the animal carcass using the game hoist.

14. The method of claim 10, further comprising the step of adjusting a height of the first and second vertical supports.

15. The method of claim 10, wherein the first lateral support and the second lateral support are pivotally connected to the connector, and securing the lateral support comprises pivoting the first lateral support and the second lateral support from a collapsed position to a deployed position.

16. The method of claim 10, wherein the first lateral support and the second lateral support each comprise a sliding sleeve, and further comprising the step of adjusting a position of the first lateral support and the second lateral support by sliding the sliding sleeves along the first upright support and the second upright support.

17. The method of claim 10, wherein the top end comprises a top connector and assembling the animal support comprises connecting releasable between the top connector and the first upright support and the second upright support.
